(19) United States
(12) Patent Application Publication
(10) Pub. No.: US 2005/0005484 A1
(43) Pub. Date: Jan. 13, 2005

(54) Vehicle license plate holder with supports for sensing devices

(75) Inventor: Giuseppe Simonazzi, Reggio Emilia (IT)

Correspondence Address: MODIANO & ASSOCIATI, Via Meravigli, 16, MILANO, 20123, IT

(73) Assignee: META SYSTEM S.P.A.

(21) Appl. No.: 10/882,160

(22) Filed: Jul. 2, 2004

(30) Foreign Application Priority Data
Jul. 11, 2003 (IT) MO2003U000024

(51) Int. Cl. G09F 7/00

(52) U.S. Cl. 40/200

(57) ABSTRACT

A vehicle license plate holder with supports for sensing devices, comprising a flat frame body coupleable to a vehicle, a license plate receptacle formed on one of the opposite faces of the frame body, and at least one pair of supports for at least one respective sensing device, which is formed proximate to the perimetric portion of the frame body; the supports are constituted by a hollow element for containing a respective sensing device and are arranged along respective axes that are non-parallel and are oblique with respect to the plane of arrangement of the frame body, the axis of one of the supports converging toward the frame body, the sensing field of the respective device being a front region of the frame body, the axis of another support diverging from the frame body, the sensing field of the device being a corner region of the vehicle.

The present invention relates to a vehicle license plate holder with supports for sensing devices such as sensors, transducers, microcameras or the like.

### BACKGROUND OF THE INVENTION

Vehicle license plate holders are known which are essentially constituted by a substantially flat frame body provided with means for coupling to the body of a vehicle or to a bumper of a car or to the fender of a motorcycle and with a receptacle for placing a license plate, which is formed on one of its two opposite faces and at which there are means for anchoring said license plate to the frame body.

Known license plate holders include holders that are termed “universal” because they are provided with anchoring means that can be adapted to license plates having different shapes and/or dimensions: the anchoring means can be constituted for example by a plurality of holes or slots having various shapes and distributed on the bottom of the receptacle for the license plate, in order to insert in said holes or slots threaded means for locking said license plate, and/or by elastic press-tabs and/or ribs or teeth of a detachable type, by eliminating which it is possible to vary the perimeter that delimits the license plate receptacle.

License plate holders of the universal and non-universal type are known which are provided with supports for sensing devices, such as for example sensors, transducers, microcameras or the like, which are suitable for example to identify and locate objects that lie outside the vehicles, to measure the relative distance between said objects, or others, and are part of signaling, alarm, control or safety equipment with which said vehicles can be equipped in order to assist their drivers for example in maneuvers for parking, reversing, driving in critical weather conditions with low visibility (fog, rain, et cetera).

Known supports are generally distributed along the outer perimetric portion of the frame body and can be formed monolithically with it or in separate tabs that can be connected thereto by way of fixing means.

Known types of support are constituted by hollow rounded elements (such as rings) or cylindrical ones (such as capsules), the main or longitudinal axis of which is oriented at right angles to the plane of arrangement of the frame body of the license plate holder; the field of action of the sensing devices is substantially constituted by the region that lies in front of the respective supports.

However, these last known license plate holders, while allowing to fit sensing devices also to vehicles for which the manufacturer does not provide them as standard or optional accessories, have drawbacks, including the fact that the breadth and shape of the field of action of the sensing devices that they support are limited and in particular cannot be compared to those of the fields of action of the sensing devices provided by vehicle manufacturers as standard or optional accessories.

It is noted in fact that vehicle manufacturers can provide, during design, for a plurality of seats for containing the sensing devices, which are variously orientated and distributed not only proximate to the license plate holder but also for example along the front and/or rear bumper, so that the field of action of said sensing devices includes both the regions that lie ahead of the front part or behind the rear of the vehicles, and their corner regions.

The field of action of the sensing devices supported by known license plate holders, by being essentially constituted by the region that lies in front of the respective supports and in view of their orientation, instead substantially coincides with the region that lies ahead of the front part or behind the rear of the vehicle, depending on where the license plate holders are coupled; therefore, the corner regions of the vehicles, which are also the regions that are less clearly visible to drivers, remain in shadow, i.e., are excluded from the field of action.

Accordingly, known license plate holders do not allow to detect any external objects that, during the motion or maneuvering of the vehicle, might be in said corner regions, making a collision with them probable if not inevitable.

### SUMMARY OF THE INVENTION

The aim of the present invention is to eliminate the drawbacks noted above of known license plate holders, by providing a vehicle license plate holder with supports for sensing devices, such as sensors, transducers, microcameras or the like, that allows to improve the shape and increase the breadth of the field of action of said sensing devices, extending them also to the corner regions of said vehicles.

Within this aim, an object of the present invention is to provide a vehicle license plate holder that is simple, relatively easy to provide in practice, safe in use, effective in operation, and has a relatively low cost.

This aim and this and other objects that will become better apparent hereinafter are achieved by the present vehicle license plate holder with supports for sensing devices, such as sensors, transducers, microcameras or the like, comprising a substantially flat frame body that is provided with means for coupling to a vehicle, a license plate receptacle formed on one of the two opposite faces of said frame body, means for anchoring said license plate to said frame body, and at least one support for at least one sensing device, such as a sensor, a transducer, a microcamera or the like, which is formed proximate to the perimetric portion of said frame body, characterized in that it comprises at least one pair of said supports, each of which is constituted by a hollow element for containing a respective sensing device, said supports being arranged along respective axes that are not mutually parallel and are oblique with respect to the plane of arrangement of said frame body, the axis of one of said supports converging toward said frame body, the sensing field of the respective device being constituted substantially by the region that lies substantially in front of said frame body, the axis of the other one of said supports diverging from said frame body, the sensing field of the respective device being constituted substantially by a corner region of said vehicle.

### BRIEF DESCRIPTION OF THE DRAWINGS

Further characteristics and advantages of the present invention will become better apparent from the following detailed description of a preferred but not exclusive embodiment of a vehicle license plate holder with supports for sensing devices such as sensors, transducers, microcameras or the like, illustrated by way of nonlimiting example in the accompanying drawings, wherein:

FIG. 1 is a schematic front view of an end portion of a license plate holder according to the invention;

FIG. 2 is a schematic side view of the end portion of the license plate holder of FIG. 1;

FIG. 3 is a schematic top view of the end portion of the license plate holder of FIG. 1;

FIG. 4 is a schematic bottom view of the end portion of the license plate holder of FIG. 1;

FIG. 5 is a schematic sectional view, taken along the line V-V, of the end portion of the license plate holder of FIG. 1;

FIG. 6 is a schematic sectional view, taken along the line VI-VI, of the end portion of the license plate holder of FIG. 1.

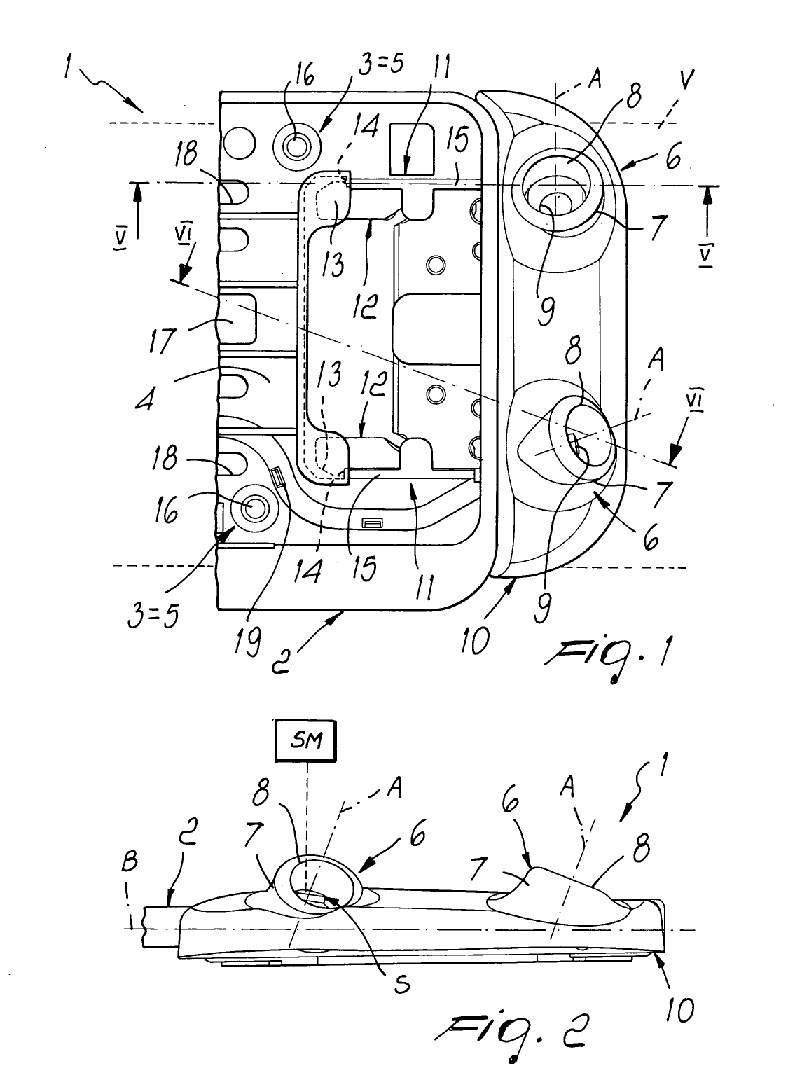

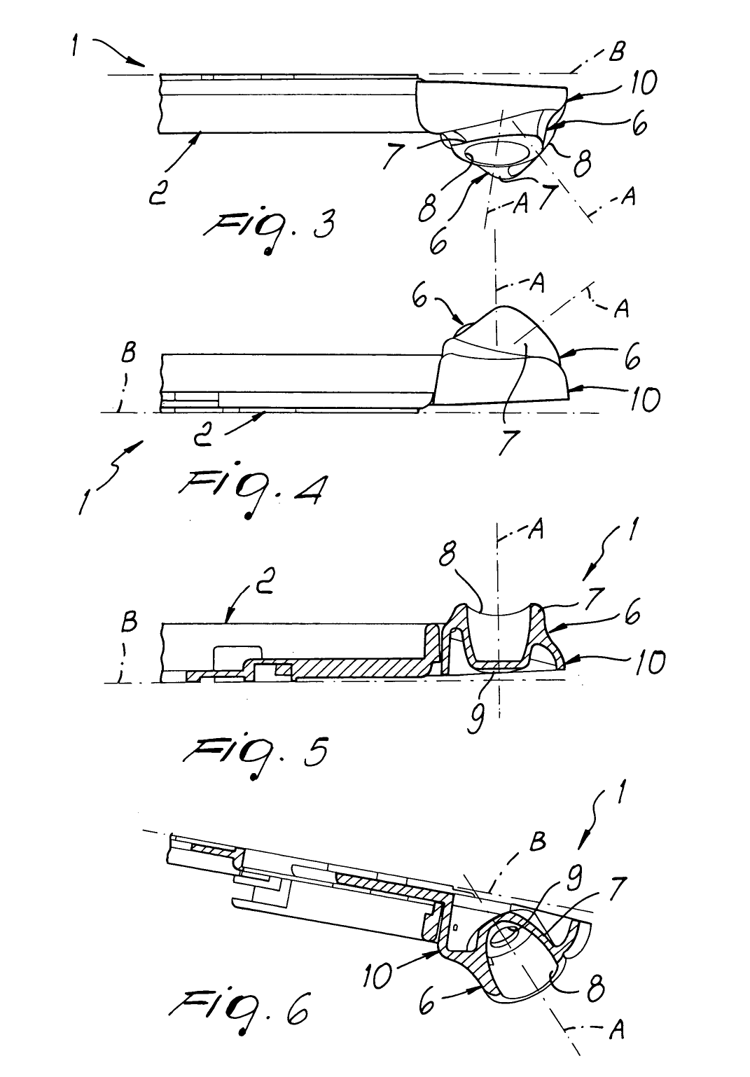

### DESCRIPTION OF THE PREFERRED EMBODIMENTS

With reference to the figures, the reference numeral 1 generally designates a vehicle license plate holder with supports for sensing devices such as sensors, transducers, microcameras or the like.

The license plate holder 1 comprises a frame body 2, which is substantially flat and is provided with means 3 for coupling to the body or to a front or rear bumper V of a vehicle or to a fender of a motorcycle.

A receptacle 4 for a license plate, not shown, is provided on one of the two opposite faces of the frame body 2; the license plate is fixed to the frame body 2 by way of anchoring means 5.

One or more pairs of supports 6 for sensing devices, such as sensors, transducers, microcameras or the like, which are parts of signaling, safety, alarm or control devices of a conventionally known type, are formed along the perimetric portion of the frame body 2.

Each support 6 is constituted by a hollow element 7 for containing a. sensing device S; the main axis A of each hollow element 7 intersects the plane of arrangement B of the frame body 2 along a direction that is oblique thereto.

The hollow element 7 is substantially shaped like a solid of rotation generated about the main axis of symmetry A: in a preferred embodiment, the hollow element 7 is frustum-shaped, with the larger end directed toward the outside of the vehicle and the smaller end, for supporting the sensing device, directed toward the vehicle.

Respective openings 8 and 9 are formed at each opposite end or face of the hollow element 7; the opening 8, formed at the face that is directed toward the outside of the vehicle, connects the sensing device accommodated in the hollow element 7 to the outside environment, while the opening 9, formed at the end directed toward the vehicle, allows the passage of the cables for connecting the sensing device to the apparatus of which it is a part or to a power supply.

The frame body 2 is substantially shaped like an elongated right quadrangle, at two opposite sides of which there is a respective pair of supports 6; the main axes A of the hollow elements 7 of the supports 6 of each of the two pairs are mutually non-parallel, so that the fields of action of the sensing devices accommodated respectively therein are oriented in different directions.

In particular, the axis A of one of the two hollow elements 7 (support 6) of each pair converges toward the frame body 2, the sensing field of the respective device being essentially constituted by the region that lies substantially in front of said frame body, while the axis A of the other of the hollow elements 7 (support 6) of the same pair diverges from the frame body 2 toward the outside thereof, the sensing field of the respective device being substantially constituted by a corner region of the vehicle.

Conveniently, the axes A of the two supports 6 of one pair intersect a line that is substantially parallel to one side of the frame body 2 and the two supports 6 of the same pair are arranged proximate to two consecutive comers of the frame body 2.

By arranging two pairs of supports 6 at two opposite sides of the frame body 2, the total field of action, which is the sum of the fields of action of the sensing devices accommodated in the individual supports 6, opens out so as to include, in addition to the region that lies in front of the frame body 2, also the peripheral regions (upper, lower and lateral) thereof, thus allowing to locate even any external objects that are present in the vicinity of the corner regions of the vehicles.

However, alternative embodiments, in which the pairs of supports 6 are provided in a different number and/or are distributed along the entire perimetric portion of the frame body 2 or along two consecutive sides thereof, are not excluded.

In the illustrated embodiment, the license plate holder 1 comprises one or more tabs 10 that can be associated with or connected to the perimetric portion of the frame body 2 and in each of which there are two supports 6, the respective hollow elements 7 of which are at least partially recessed therein.

Conveniently, the tabs 10 are associable with or connectable to the opposite ends of the frame body 2.

The tabs 10 are rigidly associated with the frame body 2 by way of (detachable) temporary fixing means 11, for example of the snap-acting type or interlocking type or of the threaded type.

Conveniently, the fixing means 11 can coincide with the means 3 for coupling the frame body 2 to the vehicle and/or with the means 5 for anchoring the license plate to the frame body 2.

In the figures cited above, the fixing means 11 are of the snap-acting (or fixing) type and comprise two elastic wings 12 that protrude so that they are substantial mutually parallel from one side of the tab 10 and are provided with at least one respective retention tooth 13, which is suitable to engage by abutment against corresponding locators 14 formed along respective straight guides 15 for the sliding of the elastic wings 12, which are formed in the frame body 2 so that they are substantially mutually parallel.

In an alternative embodiment, not shown, the pairs of supports 6, i.e., of hollow elements 7, can be integrated in the frame body 2 (along its sides) so as to be monolithic with it and be partially recessed therein.

Conveniently, the means 5 for anchoring the license plate to the frame body 2 can coincide with the means 3 for coupling the frame body 2 to the vehicle and can be constituted for example by holes 16 for the insertion of threaded means.

The anchoring means 5 can be advantageously of the universal type and be able to adapt to license plates having different shapes and/or dimensions; in particular, they can comprise a plurality of openings, such as holes 17, slots 18 or the like, for the insertion of the threaded means that anchor the license plate to the frame body 2, which are variously shaped and distributed on the bottom of the receptacle 4.

Finally, the license plate holder 1 comprises universal means for positioning license plates having different shapes and/or dimensions, which are constituted by detachable locators, such as teeth 19, ribs, protrusions, tabs or the like, which are formed in the receptacle 4.

The selective removal of said locators clears different positioning areas for respective license plates having different shapes and/or surface extensions.

Advantageously, the sensing device contained in the support 6 of each pair whose axis A diverges from the frame body 2 is associable with storing means SM with a program stored for processing the data detected thereby with respect to the corner of the vehicle; the distance of the objects located outside the vehicle detected by said device is calculated starting from the corner of the vehicle that is taken as reference point.

In practice it has been found that the described invention achieves the proposed aim and object.

The license plate holder according to the invention in fact allows to equip also vehicles for which the manufacturer does not provide sensing devices as standard or optional accessories with sensing devices whose total field of action has an improved shape and extent.

The license plate holder according to the invention allows, in particular, to increase the extent of the field of action of the sensing devices so as to include, in addition to the region that lies ahead of the front part or behind the rear of the vehicle, also the corner regions of the vehicles.

The license plate holder according to the invention therefore allows to also detect the presence of any external objects located proximate to the corner regions of the vehicles, facilitating and increasing safety in the maneuvers of the drivers of said vehicles.

The license plate holder according to the invention can be applied both to vehicles being manufactured and to already-manufactured and commercially available vehicles.

The invention thus conceived is susceptible of numerous modifications and variations, all of which are within the scope of the appended claims.

All the details may further be replaced with other technically equivalent ones.

In practice, the materials used, as well as the shapes and dimensions, may be any according to requirements without thereby abandoning the protective scope of the appended claims.

The disclosures in Italian Utility Model Application No. MO2003U000024 from which this application claims priority are incorporated herein by reference.

1. A vehicle license plate holder with supports for sensing devices, comprising: a substantially flat frame body; coupling means provided at said frame body for coupling to a vehicle; a license plate receptacle formed on one of two opposite faces of said frame body; anchoring means for anchoring said license plate to said frame body; and at least one pair of supports for at least one sensing device formed proximate to a perimetric portion of said frame body, each of said supports being constituted by a hollow element for containing a respective sensing device, said supports being arranged along respective axes that are mutually non-parallel and are oblique with respect to a plane of arrangement of said frame body, the axis of one of said supports converging toward said frame body, so that a sensing field of the respective sensing device is constituted by a region that lies substantially in front of said frame body, the axis of the other one of said supports diverging from said frame body, so that a sensing field of the respective sensing device is constituted by a corner region of said vehicle.

2. The license plate holder of claim 1, wherein said hollow element is substantially shaped as a solid of rotation generated about said axis.

3. The license plate holder of claim 1, wherein said hollow element is substantially frustum-shaped.

4. The license plate holder of claim 1, wherein said hollow element comprises openings formed at opposite ends or faces thereof.

5. The license plate holder of claim 1, wherein said frame body is substantially shaped as a right quadrangle.

6. The license plate holder of claim 1, wherein said pair of supports are arranged with the axes thereof intersecting a line that is substantially parallel to one side of said frame body.

7. The license plate holder of claim 1, wherein at least one of the supports of said pair of supports is formed proximate to a corner of said frame body.

8. The license plate holder of claim 1, wherein the supports of said pair of supports are formed proximate to two consecutive comers of said frame body.

9. The license plate holder of claim 1, comprising at least two pairs of said supports, which are provided at two opposite sides of said frame body.

10. The license plate holder of claim 1, comprising at least two pairs of said supports, which are provided at two adjacent sides of said frame body.

11. The license plate holder of claim 1, comprising a plurality of said pairs of supports, which are distributed along a perimetric portion of said frame body.

12. The license plate holder of claim 11, wherein said supports are integrated with said frame body and are monolithic therewith.

13. The license plate holder of claim 12, wherein said supports are at least partially recessed in said frame body.

14. The license plate holder of claim 11, comprising at least one tab, which is connectable with the perimetric portion of said frame body and in which at least one of said pairs of supports is formed.

15. The license plate holder of claim 14, wherein said supports are embedded at least partially in said tab.

16. The license plate holder of claim 14, wherein said tab is connectable at opposite ends of said frame body.

17. The license plate holder of claim 14, comprising fixing means for fixing said tab to said frame body.

18. The license plate holder of claim 17, wherein said fixing means are of a detachable type.

19. The license plate holder of claim 17, wherein said fixing means are of the snap-fixing type.

20. The license plate holder of claim 19, wherein said fixing means of the snap-fixing type comprise two elastic wings that protrude from said tab so as to be substantially mutually parallel, said elastic wings being provided with at least one respective retention tooth that is adapted to engage by abutment against corresponding locators formed along respective straight guides for the sliding of said wings, said locators and guides being provided, so as to be substantially mutually parallel, in said frame body.

21. The license plate holder of claim 17, wherein said fixing means are of the interlocking type.

22. The license plate holder of claim 17, wherein said fixing means are of the threaded type.

23. The license plate holder of claim 17, wherein said fixing means are provided so as to coincide with said anchoring means.

24. The license plate holder of claim 17, wherein said fixing means are provided so as to coincide with said coupling means.

25. The license plate holder of claim 17, wherein said coupling means are provided so as to coincide with said anchoring means.

26. The license plate holder of claim 1, wherein said coupling means, said anchoring means or both said coupling and anchoring -means comprise threaded means.

27. The license plate holder of claim 1, wherein said anchoring means are of a universal type.

28. The license plate holder of claim 26, wherein said anchoring means comprise a plurality of openings for insertion of said threaded means, formed at a bottom region of said receptacle.

29. The license plate holder of claim 1, wherein said receptacle comprises universal means for positioning license plates having different shapes and/or dimensions.

30. The license plate holder of claim 29, wherein said universal positioning means comprise detachable locators, constituted by any of ridges, protrusions, tabs and teeth, which are formed in said receptacle, so that selective removal of said locators opening positioning areas for respective license plates having a different shape and/or surface extension.

31. The license plate holder of claim 1, wherein said sensing device contained in the support of said pair provided with an axis that diverges from said frame body is provided connected to a storing means with a program stored therein for processing data acquired thereby with respect to said corner of the vehicle.
